(19) United States
(12) Patent Application Publication
(10) Pub. No.: US 2010/0088365 A1
(43) Pub. Date: Apr. 8, 2010

(54) Dynamic linking of sensor networks to presence for enhanced context

(76) Inventor: Douglas W. Varney, Naperville, IL (US)

Correspondence Address: Carmen Patti Law Group, LLC, One N. LaSalle Street, 44th Floor, Chicago, IL, 60602, US

(21) Appl. No.: 12/286,857

(22) Filed: Oct. 2, 2008

(51) Int. Cl. G06F 15/16

(52) U.S. Cl. 709/203

(57) ABSTRACT

An apparatus in one example has: at least one watcher and at least one subject; a presence server operatively coupled to the at least one watcher; at least one location infrastructure operatively coupled to the presence server; location information associated with the at least one subject and formed by the location infrastructure; a presentity presence document associated with the at least one subject, the presentity presence document being stored in the presence server; at least one sensor presence adaptor operatively coupled to the presence server; at least one sensor system having at least one sensor in a respective coverage area; and at least one sensor location database operatively coupled to the sensor presence adaptor, the sensor location database storing respective location data of the sensors; wherein the presence server, utilizing the location information of the subject and the respective location data of the sensors, effects monitoring of the subject by the watcher.

### TECHNICAL FIELD

The invention relates generally to communication systems, and in particular to linking a sensor network to a presentity.

### BACKGROUND

In general a presence server is a software platform that gathers presence information from multiple sources, aggregates it, and then shares it to clients and applications that are interested in it, and it does it all in real-time. The presence server may have a presence manager, which manages the flow of presence information maintaining the most up-to-date status on presence. In order to do this it may consults an availability rules manager which holds a set of logical rules that allows the presence manager to estimate “presence”. The presence server may be operatively coupled to at least one sensor system.

Sensor systems are designed to accomplish vertical applications. Those applications are not designed to provide information dynamically linked to the variety of people or objects that come into the area it is sensing. At best, a cumbersome manual process is used to link sensor information to subjects that are in the range of that sensor system.

The known art involves non-dynamic linking of an application to sensors. The following are examples. If a parent (at work) wants to check on the visual status of a child (at home), the parent must check each camera in a house until the child is in the picture. If a person wants to be notified when there is a fire in the building where they or their family members are currently (department store, high school, hospital, etc.) it would take a manual checking of an incoming fire sensor, know its location, and then determine if it matches the location of the people. For advertising purposes, a tire store would like to be notified when a particular person's car tires are worn. However, presently it is up to the car owner to notify the tire store that new tires are needed.

### SUMMARY

One embodiment according to the present method and apparatus is an apparatus that may comprise: at least one watcher and at least one subject; a presence server operatively coupled to the at least one watcher; at least one location infrastructure operatively coupled to the presence server; location information associated with the at least one subject and provided by the location infrastructure; a presentity presence document associated with the at least one subject, the presentity presence document being stored in the presence server; at least one sensor presence adaptor operatively coupled to the presence server; at least one sensor system having at least one sensor in a respective coverage area; and at least one sensor location database operatively coupled to the sensor presence adaptor, the sensor location database storing respective location data of the sensors; wherein the presence server, utilizing the location information of the subject and the respective location data of the sensors, effects monitoring of the subject by the watcher.

Another embodiment according to the present method and apparatus is an apparatus that may comprise: at least one watcher and at least one subject; a presence server operatively coupled to the at least one watcher via an IMS network; the presence server having a sensor presence network adapter and a location presence network adapter; at least one location infrastructure operatively coupled to the location presence network adapter; location information associated with the at least one subject and provided by the location infrastructure; a presentity presence document associated with the at least one subject, the presentity presence document being stored in the presence server; at least one sensor system having at least one sensor in a respective coverage area; and at least one sensor location database operatively coupled to the sensor presence network adapter, the sensor location database storing respective location data of the sensors; wherein the presence server, utilizing the location information of the subject and the respective location data of the sensors, effects monitoring of the subject by the watcher via the presence server.

Another embodiment according to the present method and apparatus is a method that may comprise the steps of: requesting by a watcher sensor information from a presence server about a presentity; obtaining by presence server a current location of the presentity; determining by the presence server an identity and type of sensors that are close to the presentity; creating a notify message with sensor characteristics and sending, by the presence server, the notify message to the watcher; and utilizing location information of the presentity and respective location data of the sensors, to effect monitoring of the presentity by the watcher.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 depicts a sensor system for use in an embodiment according to the present method and apparatus.

FIG. 2 is a general diagram that depicts one embodiment according to the present method and apparatus.

FIG. 3 is a more detailed diagram that depicts another embodiment according to the present method and apparatus.

FIG. 4 is another detailed diagram that depicts an alternative embodiment according to the present method and apparatus.

FIG. 5 is a more detailed diagram that depicts another embodiment according to the present method and apparatus.

FIG. 6 is a flow diagram that depicts a method embodiment according to the present method and apparatus.

### DETAILED DESCRIPTION

Some of the basic concepts of the present method and apparatus are as follows.

1) A subject (“presentity” in presence terminology) has a location that is known and that changes.

2) A set of sensors (whose location and coverage are known) provides information about the environment in the neighborhood of the sensor.

3) A client (person or application—“watcher” in presence terminology) desires context (presence) information about the subject.

These concepts are embodied in the present method and apparatus such that the “watcher” person/application is provided the context of the subject from the sensors in the vicinity of that subject. The watcher and systems that obtain the context of the subject may be operatively couple via a communication system. As used herein the watcher is the client that is requesting presence information, and the presentity is the entity (subject) described by the presence information.

In general a communication system may be an IMS network system, a SIP network system, a web services system, or any other type of communication system that operatively couples terminals and other systems and devices to one another. A terminal, as used herein, may refer to a landline terminal, a wireless terminal, a VoIP phone, a personal data assistant, a personal computer, etc. In the examples described below an IMS network is used.

The depicted embodiments involve mobile persons or any device that is mobile enabled and, in particular, whose location can be determined. Sensor networks may be used to track or monitor a subject. Such sensors may be any type of sensor, such as, audio microphones, video cameras, temperature sensors, pollen sensors, radiation sensors, chemical sensors, etc. Also, various systems may be used to find the subject, such as global positioning systems (GPS), geo-fencing systems, and cell sector location that reports the center of a cell/sector as a mobile terminal position.

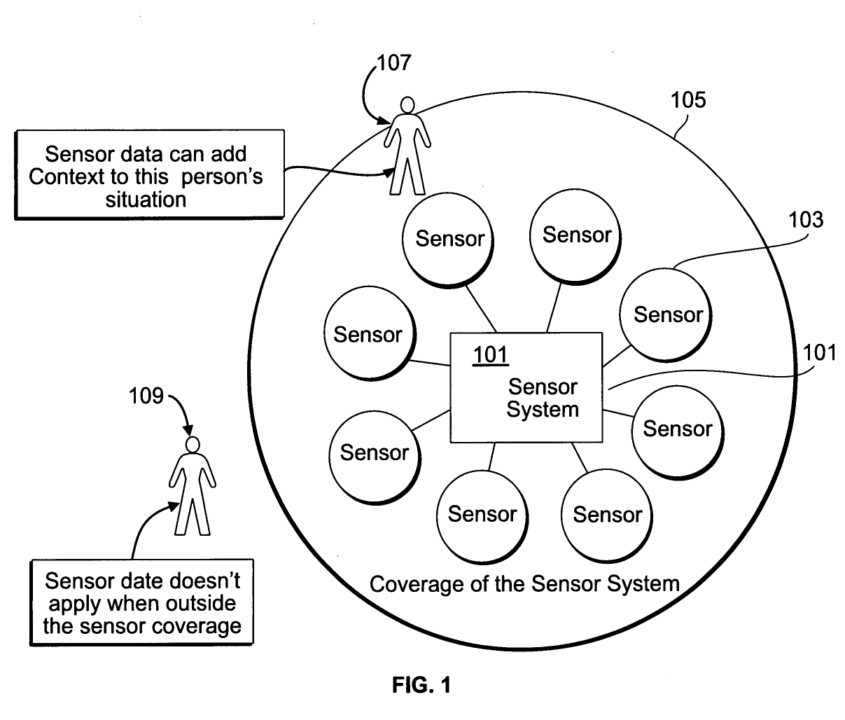

FIG. 1 depicts in general a sensor system for use in an embodiment according to the present method and apparatus. The sensor system 101 may be as simple as a single sensor, or may have a plurality of sensors 103 operatively coupled to the sensor system 101. The sensors 103 may all be of one type, or may be composed of different types of sensors.

In the FIG. 1 diagram the sensor system 101 and the sensors 103 are operational in a defined geographical area 105. In this example, a first person 107 is inside of the area 105, and a second person 109 is outside of the area 105. Even though the locations of both the first and second persons 107, 109 may be identified, the present embodiments can add context to the first person's 107 situation. However, there is no sensor data for the second person 109.

In embodiments of the present method and apparatus may be used in a large number of different applications. For example,

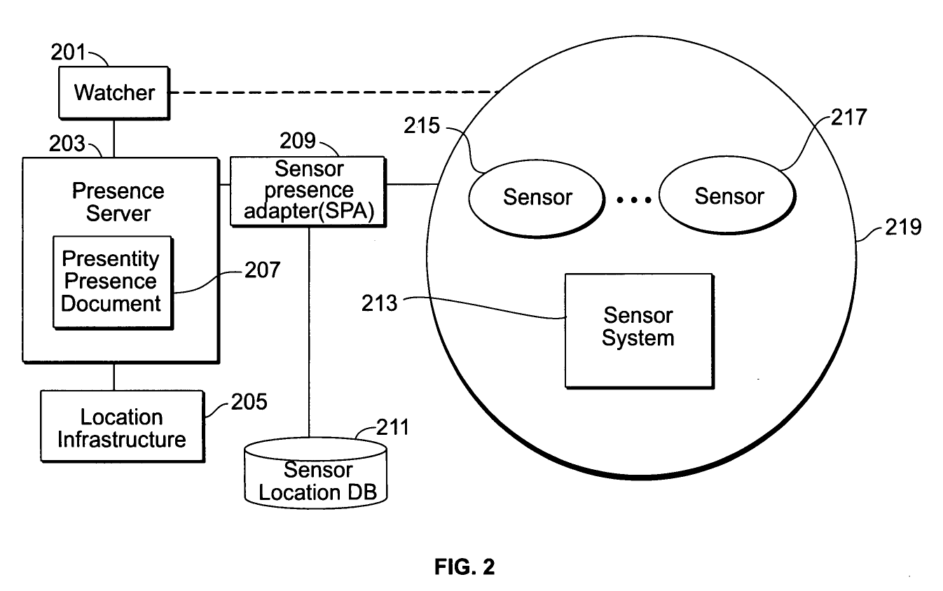

FIG. 2 is a general diagram that depicts one embodiment according to the present method and apparatus. In this embodiment a watcher 201 is operatively coupled to a presence server 203. The presence server 203 is also operatively coupled to a location infrastructure 205 (example: GMLC/SLMC in GSM network). Location information received from the location infrastructure 205 is added to a presentity presence document 207. A sensor presence adaptor 209 is operatively coupled to a sensor location database 211, a sensor system 213, and the presence server 203. The sensor system 213 may be operatively coupled to one or more sensors, such as sensors 215, 217. The sensor system 213 has a coverage area 219, which is a function of the number and locations of the sensors 215, 217. In general they form a sensor network. The sensor location database 211 may contain the locations covered by the sensors/sensor networks. The “presence watchers” use the sensor data in the context of the presentity.

A presence server is assumed to contain context information about the subject (“Presentity” in presence terminology) and part of this context information is the subject's location. This location is then compared to location coverage area of sensors as part of the sensor system. Sensors that are currently in the range of the presentity would have either their identity/address and/or information added to the presentity's presence document. External entities (“Watchers” in presence terminology), when requesting presence information about the presentity (and properly passing the privacy screening) will receive presence information that contains the data from the applicable sensors. This has a benefit of greater context provided about the subject to external entities (either human or application)

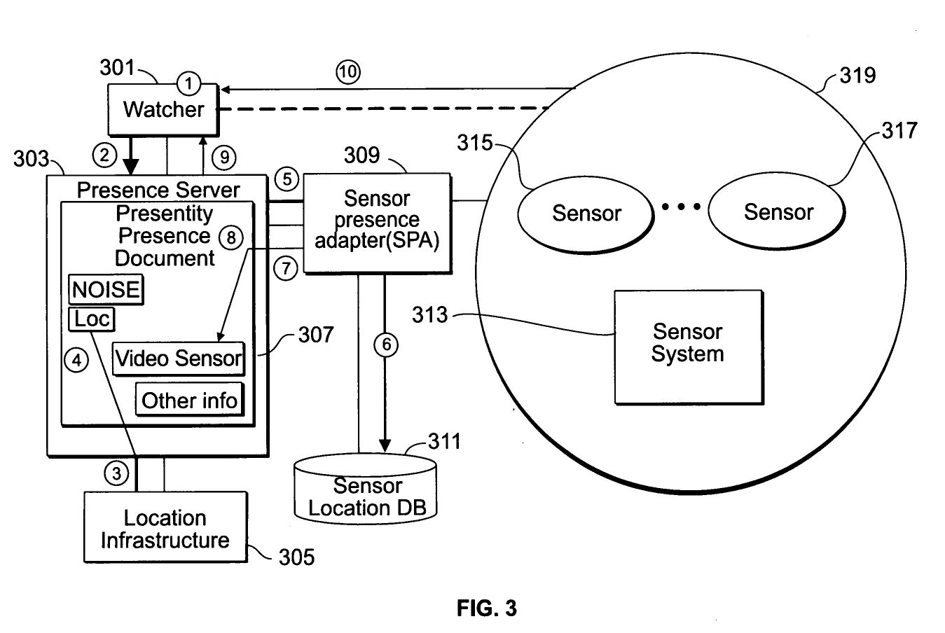

FIG. 3 is a more detailed diagram that depicts another embodiment according to the present method and apparatus. In this embodiment a watcher 301 is operatively coupled to a presence server 303. The presence server 303 is also operatively coupled to a location infrastructure 305 (example: GMLC/SMLC in GSM network). Location information received from the location infrastructure 305 is added to a presentity presence document 307. A sensor presence adaptor 309 is operatively coupled to a sensor location database 311, a sensor system 313, and the presence server 303. The sensor system 313 may be operatively coupled to one or more sensors, such as sensors 315, 317. The sensor system 313 has a coverage area 319, which is a function of the number and locations of the sensors 315, 317. In general they form a sensor network. The sensor location database 311 may contain the locations covered by the sensors/sensor networks.

The following example depicts a use of the FIG. 3 embodiment in which the following steps are marked:

1. A parent (Bob) indicates to an application on their Personal Computer that he would like to be notified on changes to his child's (Alice) location.

2. The Personal Computer application 301 acts as a “presence watcher” and subscribes to Alice's presence.

3. As Alice moves to the playground, the location infrastructure 305 indicates to the presence server 303 that a location change has occurred.

4. The presence server 303 changes the location in Alice's presence document 307.

5. The sensor presence adaptor 309 (SPA) is notified of the change (and the new location).

6. The SPA 309 accesses the sensor location database 311 and determines that there is a video camera, sensor 315 that covers the playground.

7. The SPA 309 “publishes” the video camera identifier/address to the presence server 303.

8. The presence server 303 updates the video camera 315 identifier/address in Alice's presence document 307.

9. Bob's Personal Computer application 301 receives a presence update with the new location and the identifier/address of the video camera 315.

10. The application on Bob's Personal Computer 301 shows that Alice is in the playground and also streams the video from that camera 315.

The following is another example that depicts another use of the FIG. 3 embodiment in which the following steps are marked:

1. The plant superintendent (Carl) would like to talk to one of his supervisors (Dave), but at certain times and locations the plant is too noisy to facilitate voice calls.

2. An application on Carl's phone 301 acts as a “Presence Watcher” and subscribes to Dave's presence.

3. Dave's location within the plant is captured by the location infrastructure 505 and passed to the presence server 309.

4. The presence server 309 updates the location in Dave's presence document 307.

5. The sensor presence adaptor 309 is notified of the change (and the new location).

6. The sensor presence adaptor 309 accesses the sensor location database 311 and determines that there is a noise level sensor 317 for the location that Dave is currently at.

7. The sensor presence adaptor 309 accesses the sensor system 313 to retrieve the absolute level of noise.

8. The sensor presence adaptor 309 “publishes” the noise level sensor identifier/address and absolute level to the presence server 309.

9. The presence server 309 updates the noise sensor identifier/address and absolute level in Dave's presence document 307.

10. Carl phone application 301 receives a presence update with the noise level for Dave.

11. The application on Carl's phone 301 shows that Dave is in a low noise context and hence it is feasible to talk to him.

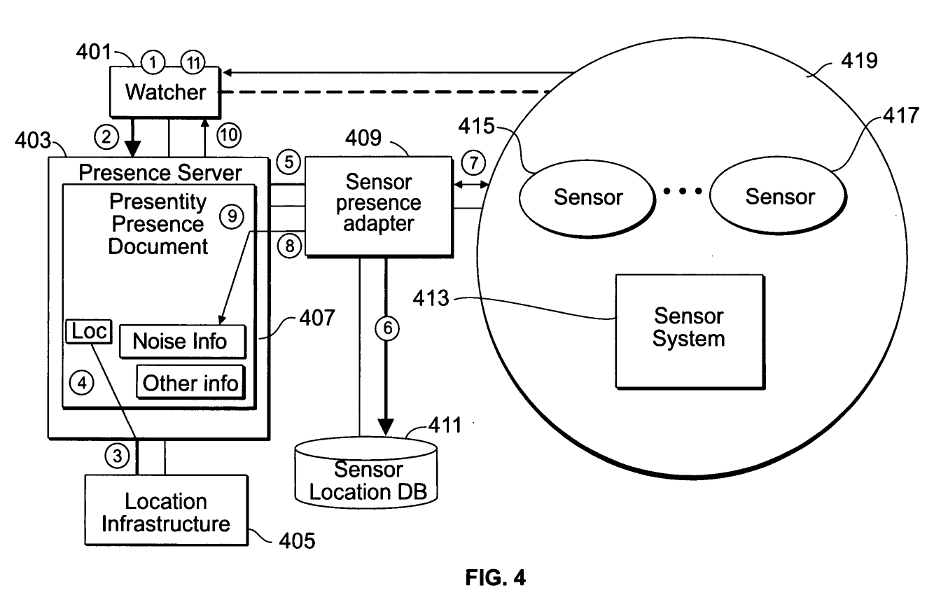

FIG. 4 is another detailed diagram that depicts an alternative embodiment according to the present method and apparatus. In this embodiment a watcher 401 is operatively coupled to a presence server 403. The presence server 403 is also operatively coupled to a location infrastructure 405 (example: GMLC/SMLC in GSM network). Location information received from the location infrastructure 405 is added to a presentity presence document 407. A sensor presence adaptor 409 is operatively coupled to a sensor location database 411, a sensor system 413, and the presence server 403. The sensor system 413 may be operatively coupled to one or more sensors, such as sensors 415, 417. The sensor system 413 has a coverage area 419, which is a function of the number and locations of the sensors 415, 417. In general they form a sensor network. The sensor location database 411 may contain the locations covered by the sensors/sensor networks.

In the alternative embodiment depicted in FIG. 4 instead of using a location matching mechanism to determine when the subject is in range of the sensor system 413, a device, such as watcher 401 (for example, the device may be a mobile phone) may interact directly with the sensor system 413 when within the coverage area 419 and that may trigger the sensor presence adaptor 409 to publish the identity/address and/or sensor value to the presence server 403.

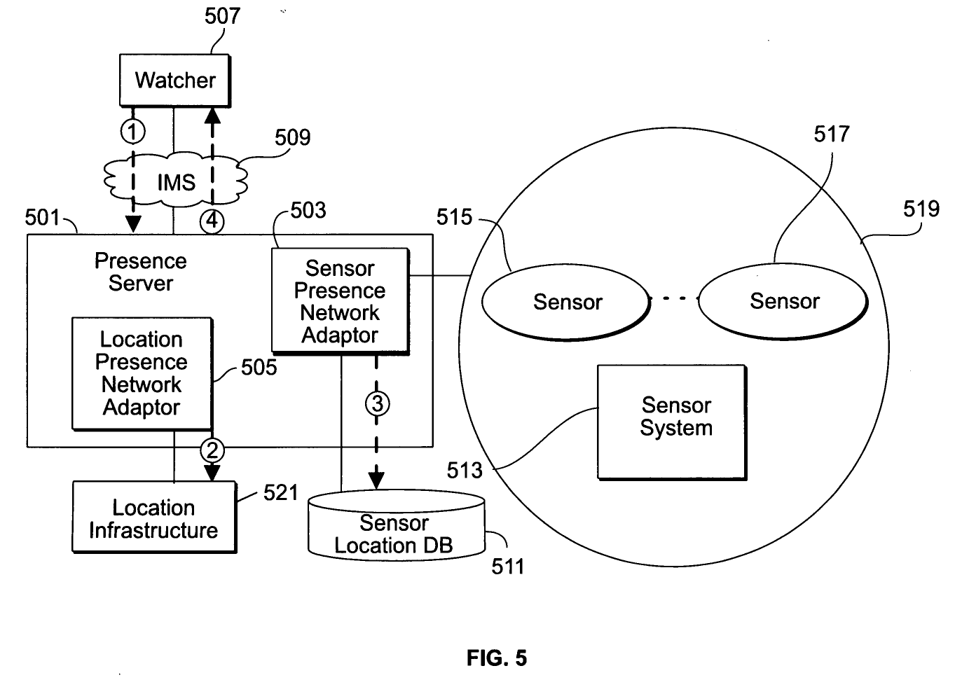

FIG. 5 is another detailed diagram that depicts another embodiment according to the present method and apparatus. In this embodiment the presence server 501 may have multiple components, two of which are the sensor presence network adaptor 503 and location presence network adaptor 505. A watcher 507 is operatively coupled to the presence server 501 via an IMS standard network architecture 509.

Initially the watcher 507 requests sensor information about a presentity from the presence server 501. SIP/SIMPLE may be used as the base protocol (IETF RFC 2778, 3856, 3863, etc.) over a 3GPP specified IMS network (S-CSCF, HSS, etc.). A SIP subscribe message may be sent to the presence server 501 with the presenty's URI. As part of the subscribe request, a filter is specified (RFC 4661, 4662) so that sensor information at the device level is requested. The presence server 501 then evaluates the filter rules and sends the subscribe message to a sensor presence network adaptor 503 (PNA) (following the model within 3GPP Presence Standards—23.141) that would deal with sensors 515, 517.

Next, the presence server 501 obtains the current location of the presentity. The location presence network adaptor 521 (in the presence server 501) either uses internal presence server documents or subscribes for location for the presentity. If the presence server 501 has the information available, then a presence document with location is provided. But more likely, sensor presence network adaptor 503 within the presence server 501 sends a SIP subscribe message (or uses internal messaging within the presence server 501) to the location presence network adaptor 521. The location presence network adaptor 521 queries a MPC (3GPP2) or a GLMC (3GPP) to obtain the location of the subscriber using a protocol such as LIF MLP. Location determination may be performed using widely deployed location technology such as A-GPS, triangulation, or Secure User Plane Location. The location presence network adaptor 521 creates the presence document with the subscriber's location (for example in (lat, long) PIDLO format as specified in RFC 4079) and is sent to the sensor presence network adaptor 503.

Next, the presence server 501 determines the identity and type of sensors that are close to the presentity. The sensor presence network adaptor 503 searches a geospatial database 511 of available sensors 515, 517 for sensors that are “close” to the Presentity's coordinates. Close will depend of the type of sensor. The database 511 is assumed to have been previously populated with the information on the applicable set of sensors. If there are sensors that are close, depending upon the sensor type, the sensor is queried by the sensor presence network adaptor 503 for its current value(s).

Finally, the presence server 501 responds to the Watcher 507. The sensor presence network adaptor 503 creates a notify message with the sensor characteristics (type of sensor, capabilities of sensor, address of sensor, sensed data, etc.). The presence server 501 (after applying proper authorization rules as per IETF, 3GPP, and OMA standards) sends the notify message to the watcher 507 via the IMS network 509. The watcher 507 receives the notify message and performs application logic.

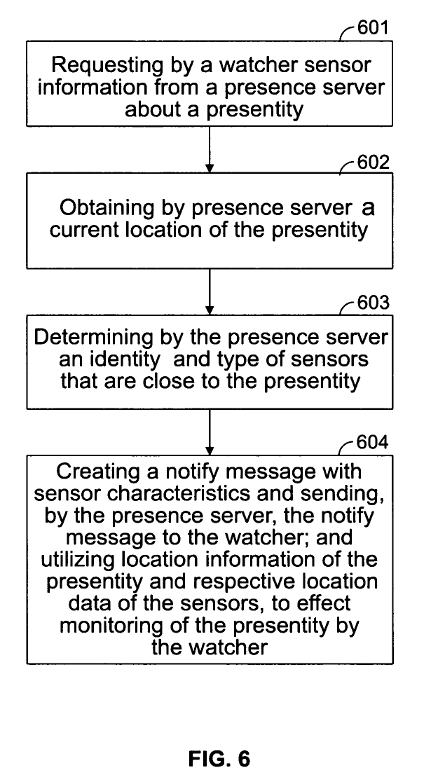

FIG. 6 is a flow diagram that depicts a method embodiment according to the present method and apparatus. The method may have the following steps: requesting by a watcher sensor information from a presence server about a presentity (step 601); obtaining by presence server a current location of the presentity (step 602); determining by the presence server an identity and type of sensors that are close to the presentity (step 603); creating a notify message with sensor characteristics and sending, by the presence server, the notify message to the watcher; and utilizing location information of the presentity and respective location data of the sensors, to effect monitoring of the presentity by the watcher (step 604).

Other embodiments of the present method and apparatus may provide a variety of different ways of observing a subject, tracking a subject, and/or observing parameters relative to a subject by a watcher (which in general may be referred to as monitoring). In an alternative embodiment the watcher may receive information from a plurality of sensors that may be displayed simultaneously in a plurality of windows on, for example, a laptop computer.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. The computer-readable signal-bearing medium for the apparatus in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following.

What is claimed is:

1. An apparatus, comprising:
at least one watcher and at least one subject;
a presence server operatively coupled to the at least one watcher;
at least one location infrastructure operatively coupled to the presence server;
location information associated with the at least one subject and formed by the location infrastructure;
a presentity presence document associated with the at least one subject, the presentity presence document being stored in the presence server;
at least one sensor presence adaptor operatively coupled to the presence server;
at least one sensor system having at least one sensor in a respective coverage area; and
at least one sensor location database operatively coupled to the sensor presence adaptor, the sensor location database storing respective location data of the sensors;
wherein the presence server, utilizing the location information of the subject and the respective location data of the sensors, effects monitoring of the subject by the watcher.

2. The apparatus according to claim 1, wherein the subject is stationary in the coverage area.

3. The apparatus according to claim 1, wherein the subject occupies a plurality of different locations in the coverage area during a time interval.

4. The apparatus according to claim 1, wherein the sensors comprise at least one of audio microphones, video cameras, temperature sensors, pollen sensors, radiation sensors, and chemical sensors.

5. The apparatus according to claim 4, wherein the sensor system has one of sensors all of the same type, and at least one of the sensors being of a different type than another of the sensors.

6. The apparatus according to claim 1, wherein the location infrastructure comprises at least one of a global positioning system (GPS), a geo-fencing system, Secure User Plane Location system, and a cell sector location system, and wherein the at least one watcher is one of a landline terminal, a wireless terminal, a VoIP phone, a personal data assistant, and a personal computer.

7. The apparatus according to claim 1, wherein the watcher is operatively coupled to the presence server via an IMS network.

8. The apparatus according to claim 1, wherein the presence server has a presence document associated with the subject, and wherein the presence document contains at least current location information that is associated with the subject.

9. The apparatus according to claim 1, wherein the sensor location database contains locations covered by the at least one sensor of the sensor system.

10. An apparatus, comprising:
at least one watcher and at least one subject;
a presence server operatively coupled to the at least one watcher via an IMS network;
the presence server having a sensor presence network adapter and a location presence network adapter;
at least one location infrastructure operatively coupled to the location presence network adapter;
location information associated with the at least one subject and formed by the location infrastructure;
a presentity presence document associated with the at least one subject, the presentity presence document being stored in the presence server;
at least one sensor system having at least one sensor in a respective coverage area; and
at least one sensor location database operatively coupled to the sensor presence network adapter, the sensor location database storing respective location data of the sensors;
wherein the presence server, utilizing the location information of the subject and the respective location data of the sensors, effects monitoring of the subject by the watcher via the presence server.

11. The apparatus according to claim 10, wherein the sensors comprise at least one of audio microphones, video cameras, temperature sensors, pollen sensors, radiation sensors, and chemical sensors, and wherein the sensor system has one of sensors all of the same type, and at least one of the sensors being of a different type than another of the sensors.

12. The apparatus according to claim 10, wherein the location infrastructure comprises at least one of a global positioning system (GPS), a geo-fencing system, Secure User Plane Location system, and a cell sector location system, and wherein the at least one watcher is one of a landline terminal, a wireless terminal, a VoIP phone, a personal data assistant, and a personal computer.

13. The apparatus according to claim 10, wherein the presence server has a presence document associated with the subject, and wherein the presence document contains at least current location information that is associated with the subject.

14. The apparatus according to claim 10, wherein the sensor location database contains locations covered by the at least one sensor of the sensor system.

15. A method, comprising:
requesting by a watcher sensor information from a presence server about a presentity;
obtaining by presence server a current location of the presentity;
determining by the presence server an identity and type of sensors that are close to the presentity;
creating a notify message with sensor characteristics and sending, by the presence server, the notify message to the watcher; and
utilizing location information of the presentity and respective location data of the sensors, to effect monitoring of the presentity by the watcher.

16. The method according to claim 15, wherein the method further comprises: using SIP/SIMPLE as a base protocol over a 3GPP specified IMS network; a SIP subscribe message being sent to the presence server with the presenty's URI; as part of a subscribe request, a filter having filter rules being specified so that sensor information at a device level is requested; the presence server evaluating the filter rules and sending the subscribe message to a sensor presence network adaptor that interfaces with the sensors.

17. The method according to claim 15, wherein the method further comprises:
the location presence network adaptor using one of internal presence server documents and subscribing for location of the presentity; if the presence server having information available, then providing a presence document with location information; sensor presence network adaptor sending a SIP subscribe message to the location presence network adaptor, the location presence network adaptor querying one of a MPC (3GPP2) or a GLMC (3GPP) or a SUPL Server (OMA) to obtain location information using a predetermined protocol, performing location determination using widely deployed location technology; the location presence network adaptor creating the presence document and sending it to the sensor presence network adaptor.

18. The method according to claim 15, wherein the method further comprises:
the sensor presence network adaptor searching a geospatial database of available sensors for sensors that are close to coordinates of the presentity, the database being populated with information on an applicable set of sensors, and querying the sensors by the sensor presence network adaptor for its current value(s).

19. The method according to claim 15, wherein the method further comprises:
the watcher receiving the notify message and performing application logic.

20. The method according to claim 15,
wherein the presentity moves out of a first coverage area, into an unknown area of no coverage, and into a second coverage area;
wherein, when the presentity moves in the first coverage area the presence server receiving presence information associated with the presentity that contains data from sensors in the first coverage area;
wherein, when the presentity moves out of a first coverage area and into an unknown area of no coverage, the presence server continuing to search for the presentity; and
wherein, when the presentity moves out of the unknown area of no coverage and into the second coverage area, the presence server receiving presence information associated with the presentity that contains data from sensors in the second coverage area.
